(19) United States
(12) Patent Application Publication
(10) Pub. No.: US 2010/0092928 A1
(43) Pub. Date: Apr. 15, 2010

(54) SYSTEM AND METHOD FOR TEACHING

(76) Inventor: Mira Stulberg-Halpert, Boca Raton, FL (US)

Correspondence Address: ROBERT M. SCHWARTZ, P.A., P.O. BOX 221470, HOLLYWOOD, FL, 33022, US

(21) Appl. No.: 12/563,796

(22) Filed: Sep. 21, 2009

Related U.S. Application Data
(60) Provisional application No. 61/098,288, filed on Sep. 19, 2008.

(51) Int. Cl. G09B 1/00

(52) U.S. Cl. 434/167

(57) ABSTRACT

A system and method of teaching proper letter and word writing is utilized by presenting a plurality of colored, measured rods, and clay with which letters are formed according to a prescribed plan.

### INDEX TO RELATED APPLICATIONS

This application claims the benefit of U.S. Provisional Patent Application No. 61/098,288, filed, Sep. 19, 2008, the disclosure of which is incorporated herein by reference in its entirety.

### SUMMARY OF THE INVENTION

The learner letter formation system and method of the present invention is a teaching methodology for success in letter formation to improve visual memory and the mastery of letter formation and letter combination to create vocabulary as a whole, the recognition of letter patterns in words, spelling in English, Spanish and Hebrew as well as numbers. Once formation skills are mastered, the system and method also increases reading and writing speed and accuracy because the student can rapidly name the word and immediately put a meaning to words. Students do not need to spend time sounding out words because they have mastered what the word is as well as what it means. Ultimately, writing the word(s) is done with less stress because the shape and formation of the letter within the word(s) is embedded in the picture in their mind.

Beginning readers or those students who struggle with reading often have difficulty recognizing letter or letter patterns as well as difficulty naming and forming letters properly. In order to read letters of words properly, it is necessary to recognize and understand what the letter symbols are, what they are used for as well as how they are formed. It is important that students, especially children, have a strong foundation for learning. It is equally important that students have an environment in which to learn that gives them the ability to both play and discover how things go together. By providing a system and method conducive to facilitating letter and word formation, students build self confidence and discover learning can be fun. This system of forming letters and words as well as meaning of words fosters a child's imagination and creativity to create—with their hands, the picture they “see” in their head.

The system and method of the present invention was initially developed for students to learn letter patterns for words. As students began using this system differences in handwriting were noted. Students using the present invention noticed spelling accuracy was increased as well as long term retention of both spelling and vocabulary. Reading comprehension and fluency increased as students remembered the words and meaning. Students learn in a fun environment and are actively engaged in an activity that stimulates creativity and visual memory. It begins with a no paper or pencil approach and children of all ages find this a fun and rewarding experience. By manipulating the clay provided as part of the present invention, students have real hands-on experience to touch, feel and create letters and words. All types of learners can benefit from the positive experience.

By measuring clay ropes to a specified color coded model for building letters, students create neural pathways using both their visual and kinesthetic systems to help them remember and understand first, how words are made and next what words mean.

Before using this program students often have:
Inconsistent size of letters;
Letter and number reversals;
Poor letter formation;
Mixing upper and lower case letters both with in words and sentences;
Poor quality of making lines evenly;
Inconsistent spacing of letters and words;
Reduced speed of knowing how to write and spell words;
Difficulty with fine-motor control; and
The ability to accurately measure, cut, and form letters consistently.

The present invention is a very specific and guided system and is developmentally sound.

Teachers and parents note when students use this program they experience less fatigue and stress and self-esteem is increased as letters and words are mastered quickly, with less effort than writing alone, and they have great pride in their work.

Often, students who have historically had difficulty spelling recognize that this process helps them spell words they previously thought were difficult. Students also note immediately how clearly they are able to transfer this ability to writing words.

The present invention was originally developed to help students use a guided approach to forming letters and then words. It was developed to increase the student's awareness of how letters are formed as well as how words are then created by putting letters in a particular order (a part to whole process). Once the word is made, the meaning is then constructed to anchor the meaning of the word.

Additional activities can enhance students experience making letters.

(Once all lowercase letters are made, or as each lowercase letter is made, a model of an object or concept that starts with that letter can also be made. For example the letter “a” is formed and the student then makes an apple out of clay.

Students are helped and encouraged to make objects that they know and can remember. The artistic quality is not what is important. This activity is meant to reinforce the visual image of the letter being learned, and by using clay, the kinesthetic activity helps to build their memory.

Once all letters are completed, students then use the colored rods to form letters that make words. Depending on the age of the student, simple sight words are spelled. Sight words are identified as words that beginning/emerging readers must learn by sight and have no particular spelling pattern to them. They are also known in children's literature as words that are difficult to picture or define. There is a prescribed Dolche list of words that is recognized in all school curriculums. Most struggling readers struggle with sight word vocabulary, and the system and method of the present invention addresses the correct spelling, knowing what the word looks like and creating a visual for its meaning.

To make words use the following steps:

Start with nouns. Nouns are easiest for students to both understand and visualize. They are also usually easier for students to create objects out of clay.
7. Choose a noun to spell. Example—dog. Write it clearly on paper for the student to see. Have the student create the letters according to the color rod guide. Make the letter d(using 2 yellow rods) the letter o (using the long green rod) and the letter g (using a yellow rod and green rod shaped into a hook shape).
8. Put the clay letters in the correct spelling order dog
9. Have the student make a likeness of a dog. Pictures can be used to help conceptualize the object. Discussion of different kinds of dogs can help the student anchor his/her visualization of a dog.
10. Have the student write the word dog on a piece of paper—using what he/she knows about how the letter was made using the clay rods. A c shape for part of the d and a vertical line that is attached to it. A round circle for the o and another c shape and hook(that goes below the line) that attaches.
11. Draw and picture and make a sentence using the word dog. Note that at least the letters of the word dog are made correctly.
12. As more words are mastered in this way, the formation of all letters should start to become more uniform.

Once nouns are mastered, students can move on to making prepositions(direction words) and other words that are difficult for students to remember. Use of this prescribed method of measuring and building words can be used for making weekly school spelling words as well as learning vocabulary words.

A “Gestalt” (a psychology term which means “unified whole”) refers to theories of visual perception developed by German psychologists in the 1920s. These theories attempt to describe how people tend to organize visual elements into groups or unified wholes when certain principles are applied

A whole picture of what the word means to the student is formed in a student's mind that matches the meaning of a word as well as what that word is. After use with many students, they themselves recognized that by forming these letters using specific measuring guides, they were able to write the letters properly on paper, using pen or pencil. This discovery led to the student wanting to write more. It also led to greater spatial awareness; if letters and words could be pictured, then writing the letters and words correctly came with less effort. The result was improved handwriting, both in formation and size and spacing. The measuring tools are designed to make letter sizing about the size that can be written on regular, elementary lined paper.

Writing assessments are generally student writing samples. They are gathered before instruction and then taken after instruction. Comparisons are made between the samples.

Formal assessments usually administered by Occupational Therapists or Psychologists include a combination of standardized and observational assessments. Note that handwriting is a functional task necessary for school-aged children to master in order to express thoughts, ideas and knowledge. The skill itself requires many sub skills including visual motor coordination, higher-level cognitive processes, perceptual abilities kinesthetic abilities, motor planning, spatial orientation as well as temporal control.

In addition to improving handwriting the 3D Learner System improves spelling, word recognition, vocabulary and long term memory.

As discussed above, there is significant development relating to various subskills.

The subskill of visual motor coordination requires that a student be able to have good fine motor skills, meaning good eye—hand coordination. By rolling out ropes of clay students need to be able to manipulate the clay to roll it into 12 to 14 inch ropes. Students must also be able to accurately measure the clay against the colored rod and cut the clay accurately. They must be able to manipulate the clay in such a way as to form the letter correctly. For beginning students (pre-K to Kindergarten), individual letter templates that match the size of the colored rod can be used to facilitate learning. Students measure the clay to the correct size and place it on the corresponding letter template.

Perceptual abilities are strengthened through strengthening visual memory, and creating letters from part to whole. Understanding that by putting certain parts together creates a particular letter symbol. Putting those letters (parts) together creates a complete word or idea (the whole).

Higher level cognitive skills or comprehension, are developed from the student having to understand and then create what the word that was made means. By having the student create his/her own meaning of the word, he/she “owns” that word.

Students responses to the ease of remembering the words or symbols they made themselves versus just writing the word in pencil/pen is overwhelming. One student responded to her Mother that “Of course I remember how to spell that word—I MADE it!” Students also report that it is easier to visualize and then remember an object that they made (out of clay) versus visualize an object that they see a picture of.

To test this memory ability, students are asked to make objects that start with the lower-case letter made (from above). Those letters and objects that have objects associated with them are remembered more easily than if a student just names an object(and writes it down) along with the letter. Students discover themselves that this process helps them remember words easier.

Spatial ability is strengthened by forming the letters properly and placing them correctly on the lined template. Students self correct by matching their clay letters and words with the printed word. The order and position of the letters must be the same.

Kinesthetic and motor planning abilities are strengthened through the constant use of hands-on learning. The manipulation of clay, rolling, measuring, cutting and forming letters are all done using the sense of touch. All of this needs to be done in a certain sequence in order to attain mastery, The student needs to be able to use his/her visual system in order to first look at the letter that is to be made. Then the correct colored rod needs to be chosen to be measured and cut. Then that piece must be placed or molded to form the corresponding part of the letter and placed properly on the template.

Correct spatial orientation, which way the letter(s) need to be placed and temporal control—the ability to control speed and accuracy of making letters, are also sub-skills supported by the use of the 3D Learner system. Students find they cannot “rush” making letters. They also find the time used to look at, measure, cut, form and place the letters in correct order to create a word, is more beneficial in mastery of the word—both in understanding what it means as well as remembering the spelling of the word, than writing it numerous times. Hundreds of students who use the 3D Learner process, have found it more useful to learn spelling words at school using this format than writing their spelling words multiple times. They have incorporated this system into their weekly spelling routine.

The letter/word building process is specifically meant to help students of all ages create, recognize, and understand words. In the process, students gain the ability to correctly create these words.

Different colored rods are used to help students differentiate the various sizes of clay pieces that are needed to build letters. Color is a tool to stimulate memory. By using different color rods, students can more easily remember what rod are needed to make different letters. If a student has difficulty remembering what letter comes next in a word, if reminded what color rods were used to make the letter, they often able to remember the name of the letter as well as the shape. Over the years of developing this system, it was found that color helped students remember the letters and how they were formed.

When first using pre-measured rods to helps students build letters, different colors were not used. Students found that when they discovered different sized rods worked better to help build the more “perfect script” letter, using color to describe the correct rod was easier than identifying it as “the medium size rod” or “the one that makes the curve”.

Color adds both fun and easily identifiable differences to make building letters easier for students.

### BRIEF DESCRIPTION OF THE DRAWINGS

FIG. 1 is a letter guide for order of making uppercase letters with letters formed into groups.

FIG. 2 is a visual guide of uppercase letters formed using measuring rods and clay.

FIG. 3 are examples of uppercase letters formed using said measuring rods and clay.

FIG. 4—Table for building all uppercase letters using measuring specific rods.

FIG. 5 is a lined template used for placing completed letters and words thereon.

FIG. 6 shows a specified order of making lowercase letters according to the present invention.

FIGS. 7 and 8 are lowercase letter combinations to be made in using the present invention.

FIG. 9 is a visual guide of uppercase letters formed using measuring rods and clay.

FIG. 10 is a visual guide of how specific lowercase letters are formed using measuring rods and clay.

FIG. 11 is a table for building all lowercase letters in words

Figure is a visual guide of rods used for building numbers, uppercase and lowercase letters in English

FIG. 13—Visual guide for building letters in Spanish.

FIG. 14—Visual guide for building letters in Hebrew.

### DETAILED DESCRIPTION OF THE PREFERRED EMBODIMENTS

The system and method of the present invention provides for teaching letters and words to students learning to write.

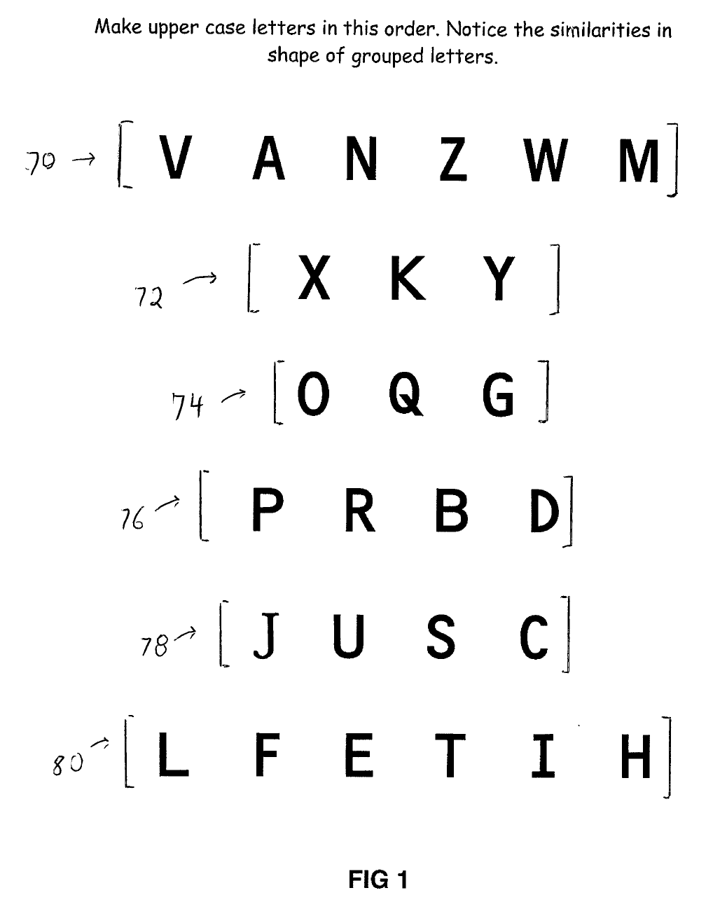

As shown in FIG. 1, the Standard English alphabet is broken into several groups. Students are trained to form letters one group at a time. The letters of first group 70, are V, A, N, Z W, and M are formed as a group due to similarities in their configuration.

All groups depicted in FIG. 1 are so grouped due to similarities in shape and configuration.

The letters of second group 72, are X, K, and Y.

The letters of third group 74 are O, Q, and G.

The letters of fourth group 76 are P, R, B, and D.

The letters of fifth group 78 are J, U, S, and C.

The letters of sixth group 80 are L, F, E, T, I, and H.

The stepwise teaching system and method of the present invention requires a student mastering formation of letters in a single group before proceeding on to subsequent groups.

In teaching uppercase letters, students are provided with a plurality of measured rods which are used to form particular letters. Students will roll and measure clay strips approximately equal to the length of a particular rod.

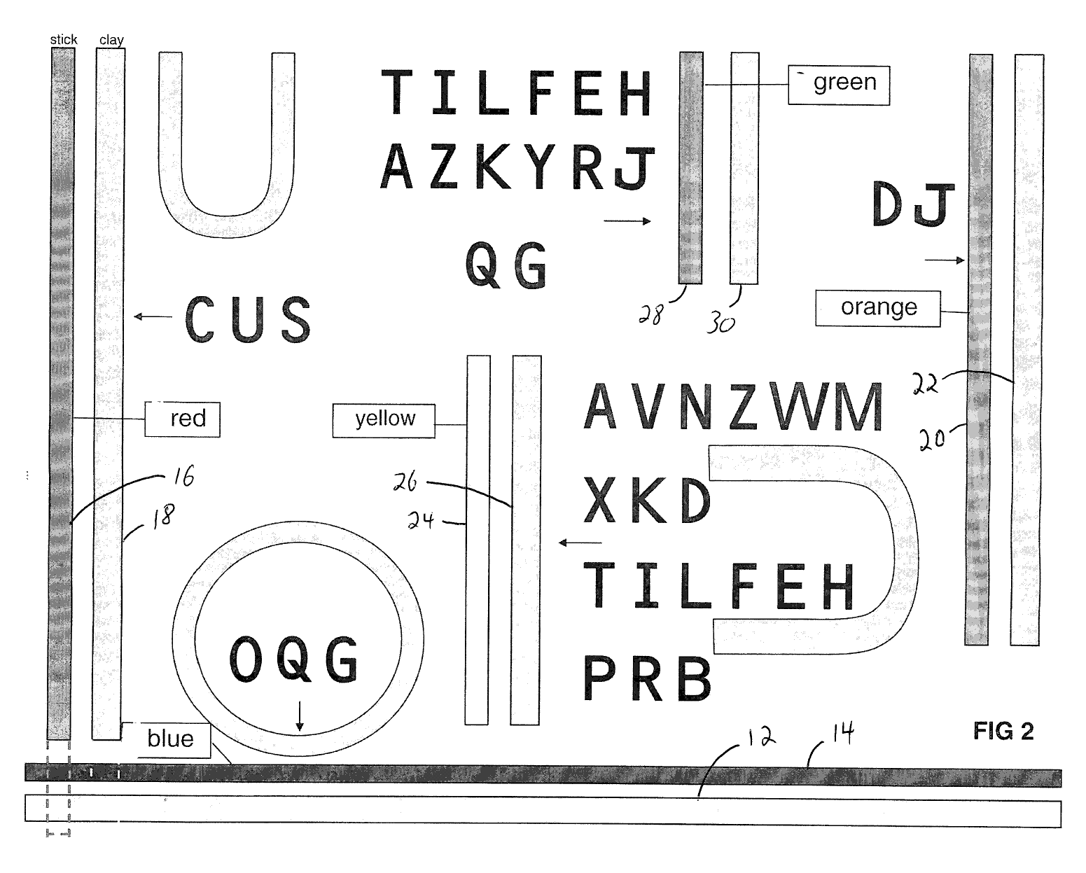

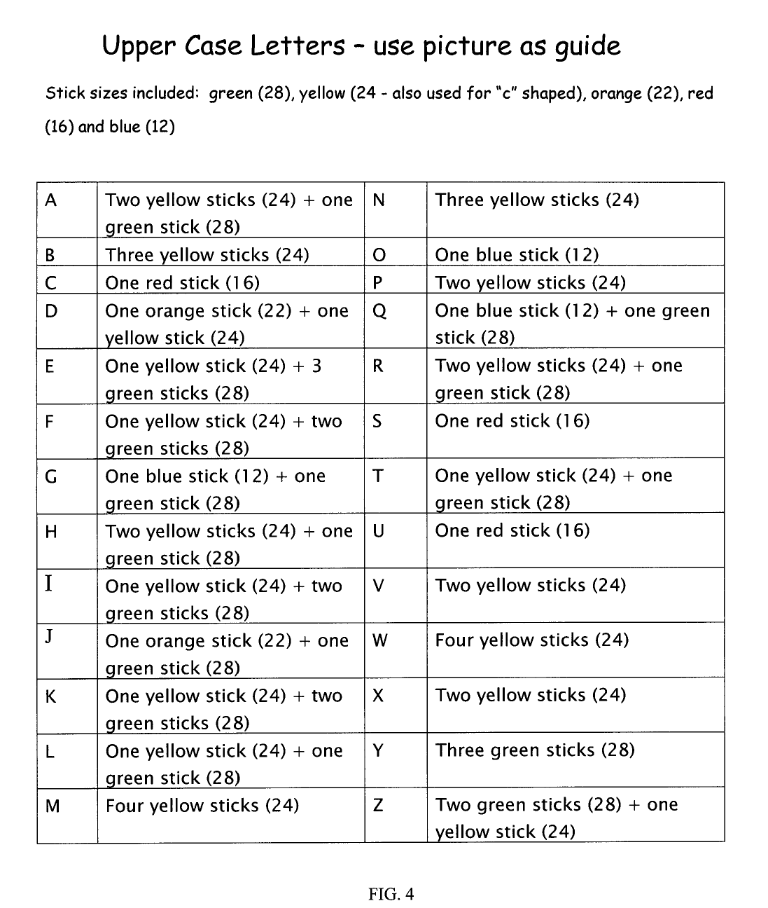

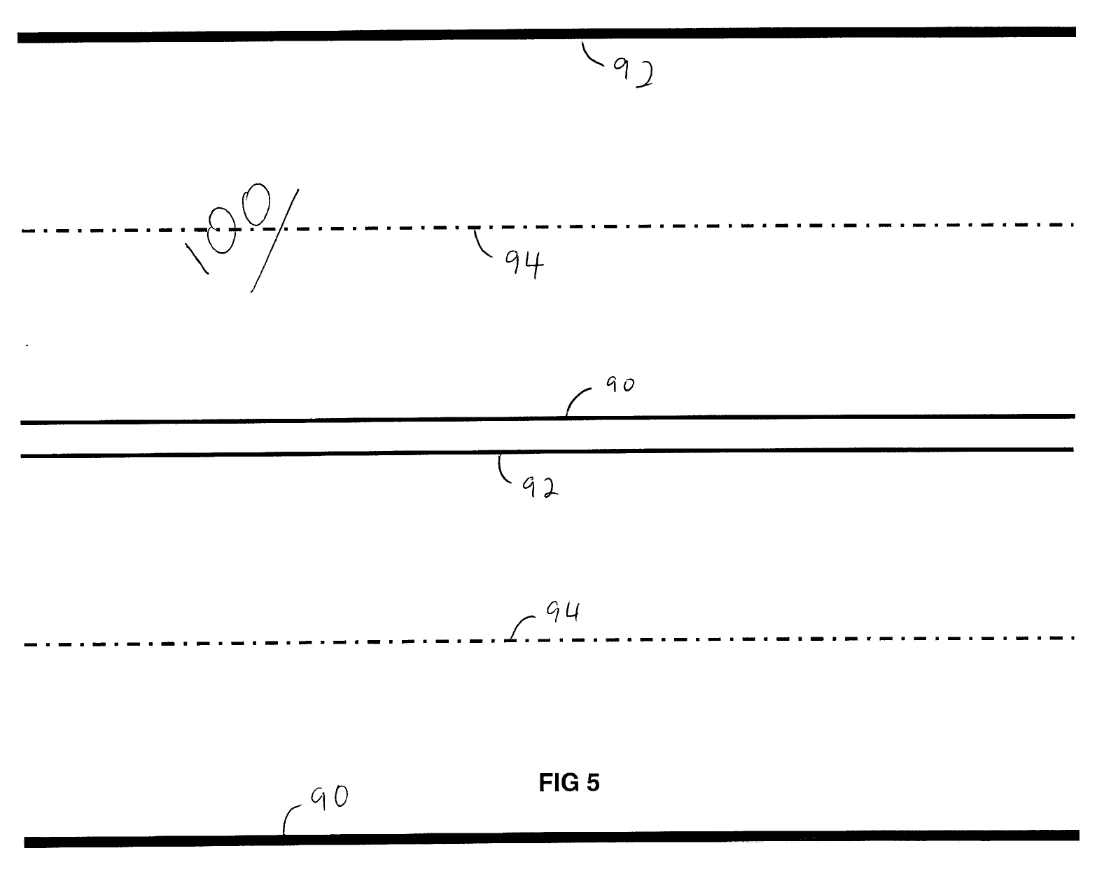

As shown in FIG. 2, a first upper case measuring rod 12 will be used to form an accompanying clay strip 14. Although the figure relates to particular colors for each measuring rod, the exact colors depicted in the figure need not be used. However, in a preferred embodiment, each of the measuring rods depicted in FIG. 2 should have a distinct color. Second upper case measuring rod 16 will be used to form an accompanying clay strip 18. Third upper case measuring rod 20 will be used to form an accompanying clay strip 22. Fourth upper case measuring rod 24 will be used to form accompanying clay strip 26. Fifth upper case measuring rod 28 will be used to form an accompanying clay strip 30. Each letter of the alphabet is formed as set forth in the table above FIG. 4. The student will select the appropriate measuring rod or rods, the student will roll clay into a strip of appropriate thickness and length and subsequently use the clay to form the desired letter.

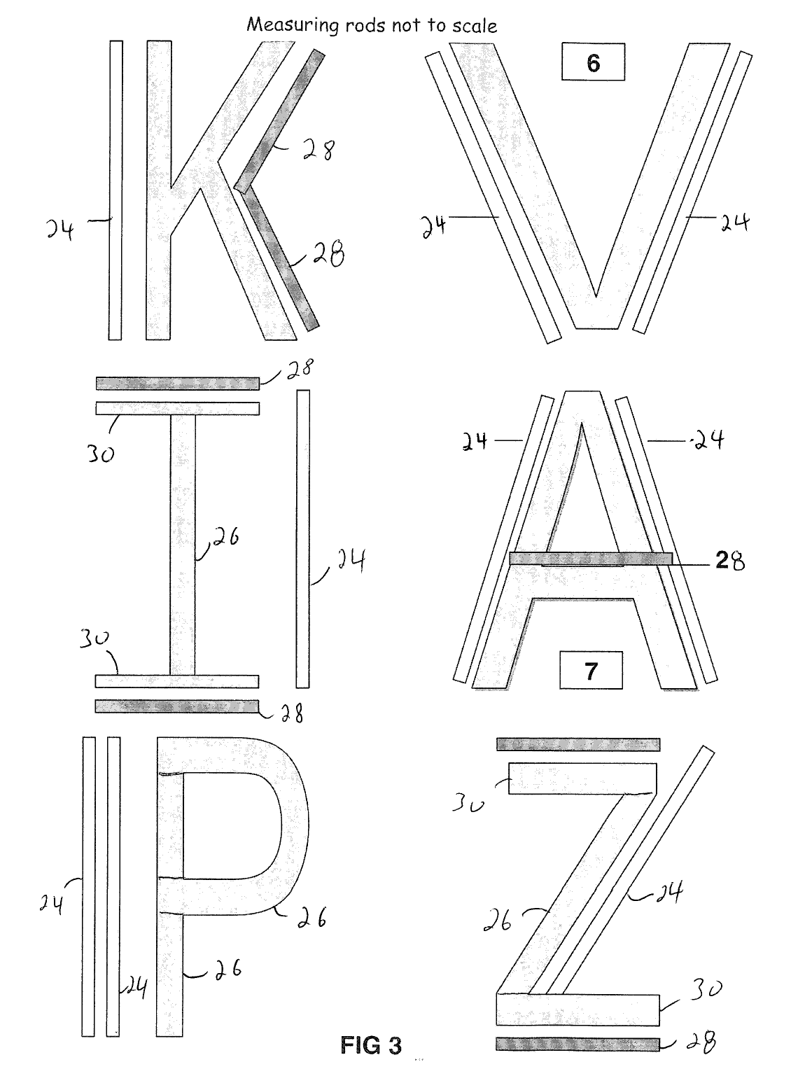

Examples of forming letters are shown in FIG. 3. Students will be given a printed substrate as in FIG. 5 as is commonly used to teach handwriting skills whereby a lower baseline 90 and an upper boundary line 92, forms a writing region that is bisected by a broken line 94. Broken line 94 is typically used as a demarcation boundary for forming lowercase letters.

Uppercase letters are formed as follows:
Upper Case Letter Construction

### Step 1

Provide colored rods and clay to the student. Roll clay ropes to 12 to 14 inch lengths and approximately ¼ inch width.

### Step 2

Using the clay ropes from step 1, the Upper Case Letter Guide (FIG. 1), and Measuring Rod Visual Guide (FIG. 2) the students begin with constructing upper case letters.

Letters are presented in specific order and grouped by similar shapes as shown in FIG. 1.

### Step 3

Make the upper case letter “V” by taking measuring rod 24 and placing it next to a rope of clay. Cut the clay rope to form clay rope 26 to the length of yellow rod 26. Measure and cut a 2^{nd} rope of clay the size of the yellow rod that will be used to make the letter V.

Place the two yellow rods together at an angle with the two points meeting at the bottom line 90 of the lined template from FIG. 5 to form the letter V, as shown in FIG. 3. Each clay rope 26 is placed alongside rods 24 to form the letter V.

### Step 4

To make the letter “A” measure two yellow rods 24 against a rope of clay to form clay rope 26, and one small green rod 28 to form clay rope 30. Place the 2 yellow rods 24 on Template 100 at angles along boundary 92, and have the ends meet at the top on boundary 92. (Students should note how this is similar to the letter “V” but upside down!) Clay rope 30 that is the size of the small green rod 28 is placed in a horizontal position along line 94, that is half way down the angle to create the upper case letter “A” as shown in FIG. 3.

### Step 5

Proceed to build all of the upper case letters in order in the prescribed manner (FIG. 1, FIG. 2, and FIG. 4). Note the similarities of each row of letters. Letters are formed in groups according to the grouping set forth in FIG. 1.

FIG. 4 is a table detailing how to build each upper case letter, both using a color chart to show which rod or rod is to be used with each letter as well as written instruction for each letter.

A guide sheet is to be included with directions to show which colored rods are needed to build which letters.

### Step 6

Once uppercase letters are completed, students can place the clay letters in traditional ABC order for comparison. All letters are to be placed on the specially designed template (FIG. 5).

### Step 7

If the letters the students make do not match the correct shape and size of the letters, encourage student to find which part does not match correctly and make the correction. Having the student start over to make the letter correctly might be a better option. Have the student compare the quality of the two letters (incorrect and correct). It is important that the shape and size of the letters be consistent.

### Step 8

Provide the student with writing paper having template 100 printed thereon.

Have the student write the uppercase letters on paper—using the proper formation of the letter as made using the clay model. Have the student self correct for size, orientation and clarity of the letters.

### Step 9

It is important in this, and every pedagogic activity, to provide positive encouragement at incremental levels of success.
Lowercase Letters

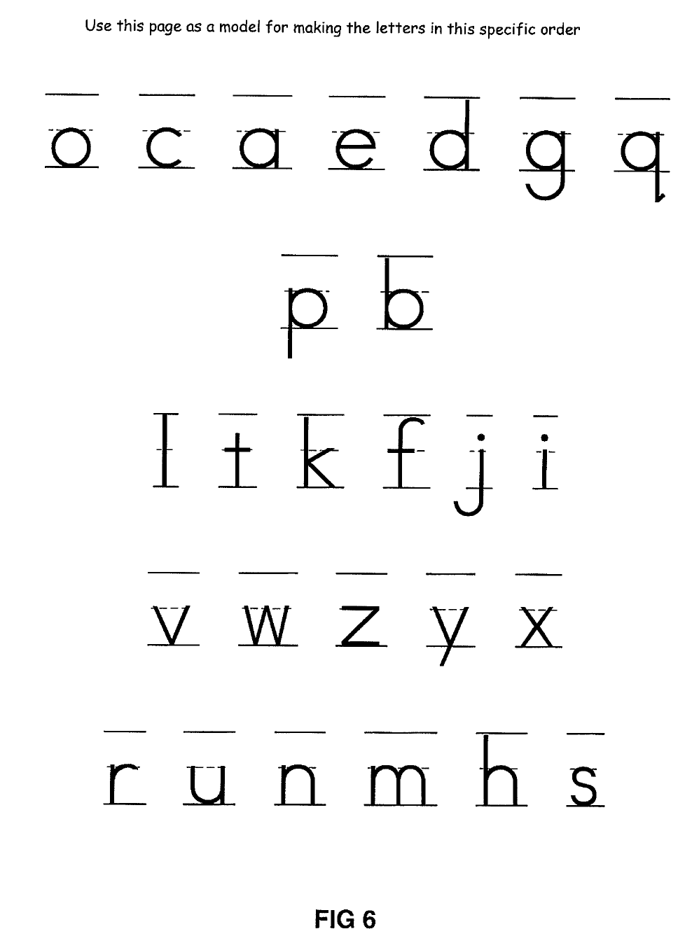

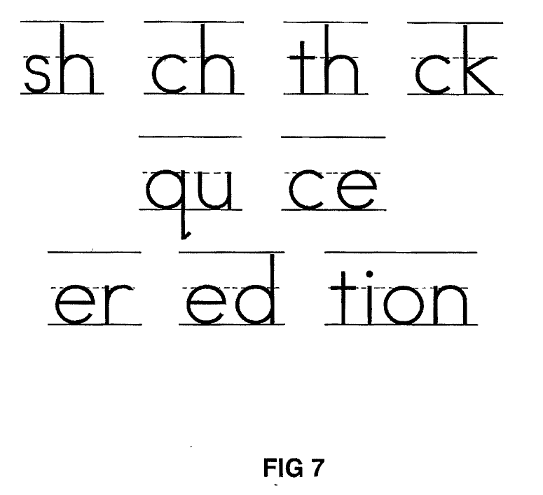

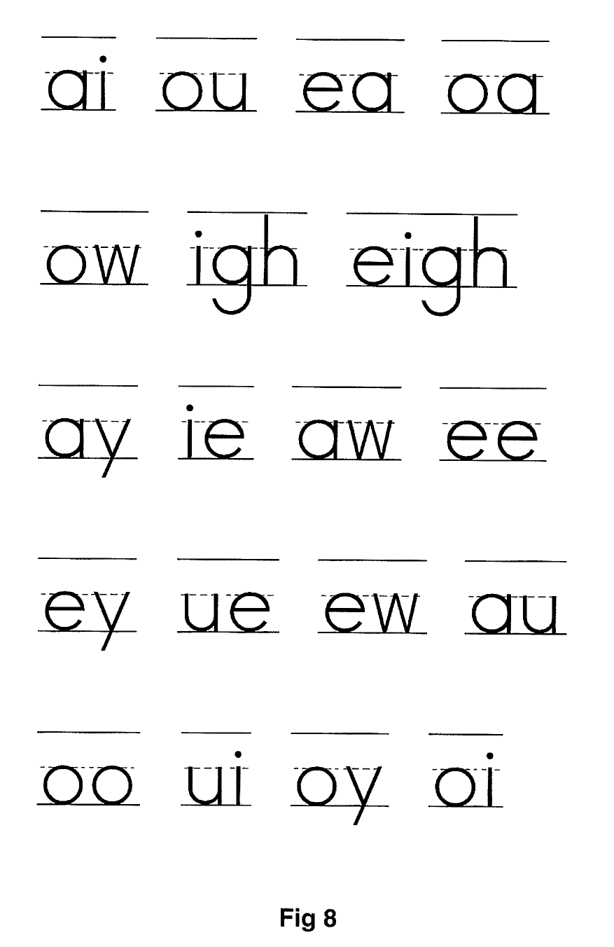

Once uppercase letters are mastered, lowercase letters can be made. Again, letters are presented in specific order, as shown in FIG. 6, of similar shape, starting with the letter o, a round circle.

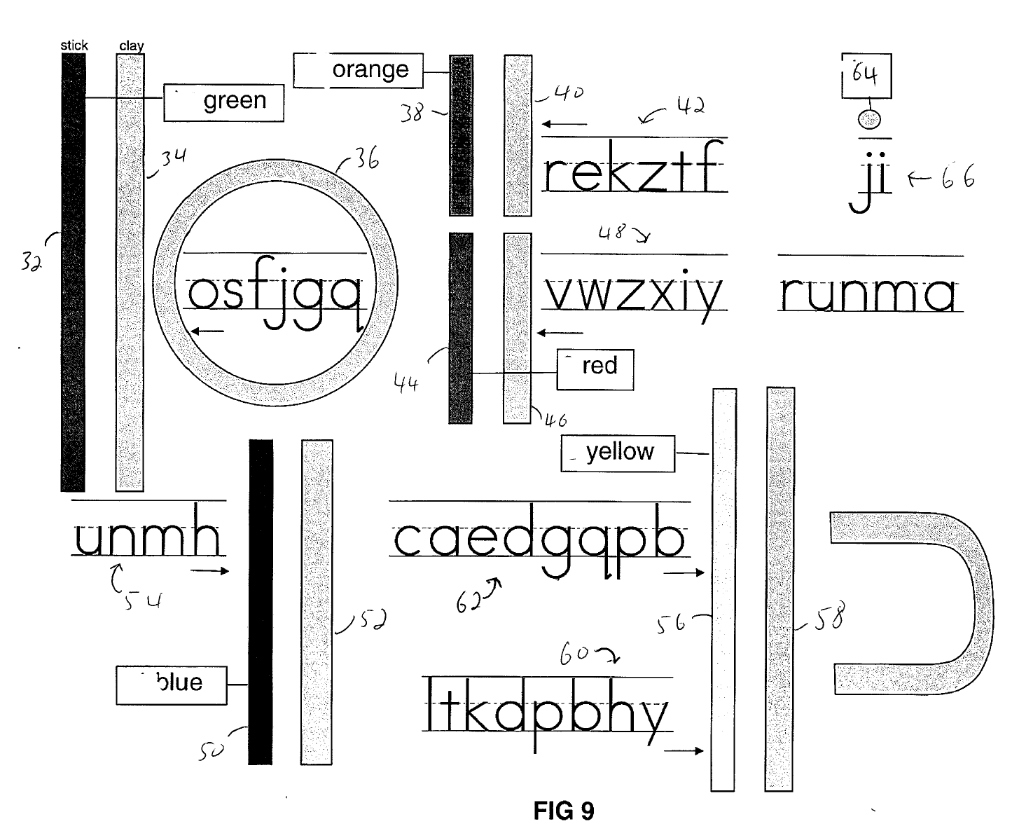

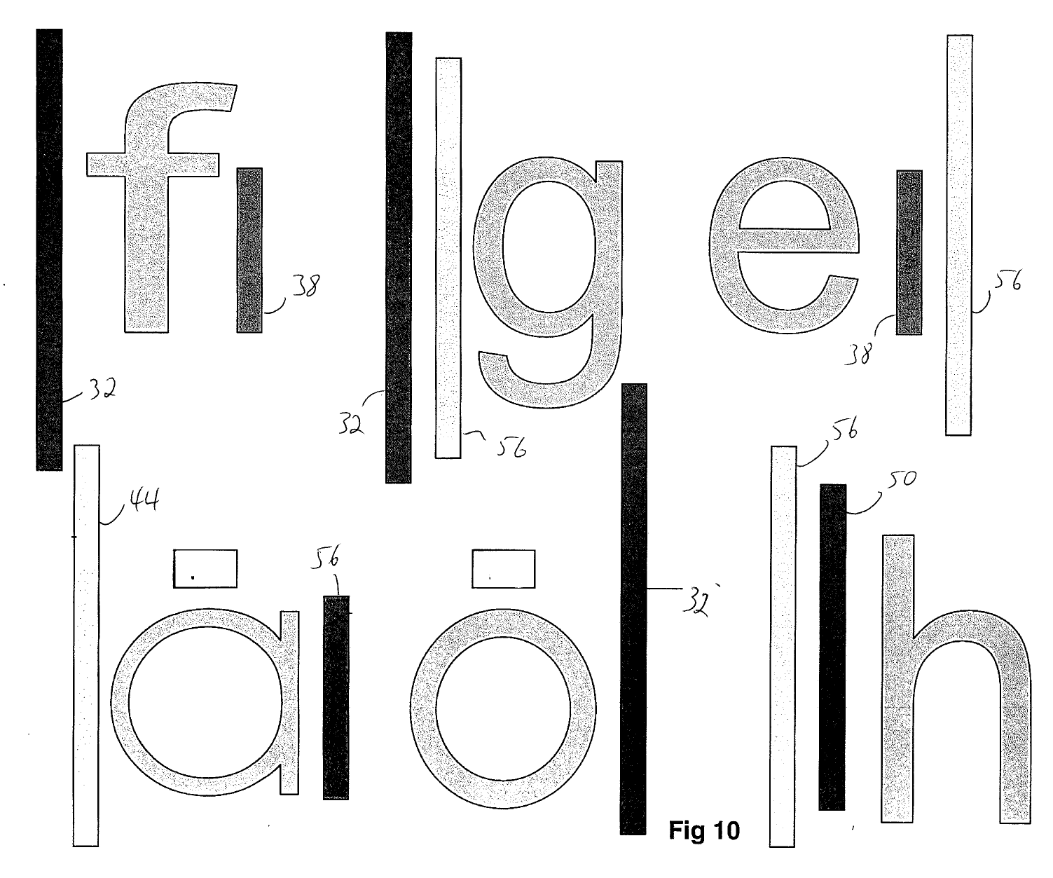

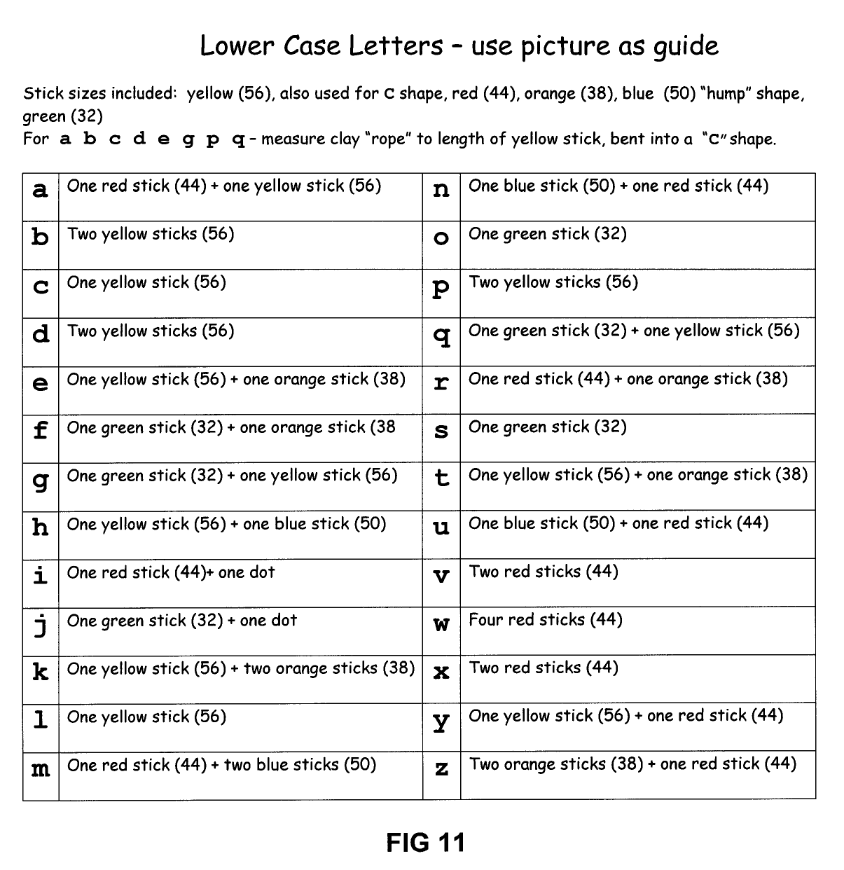

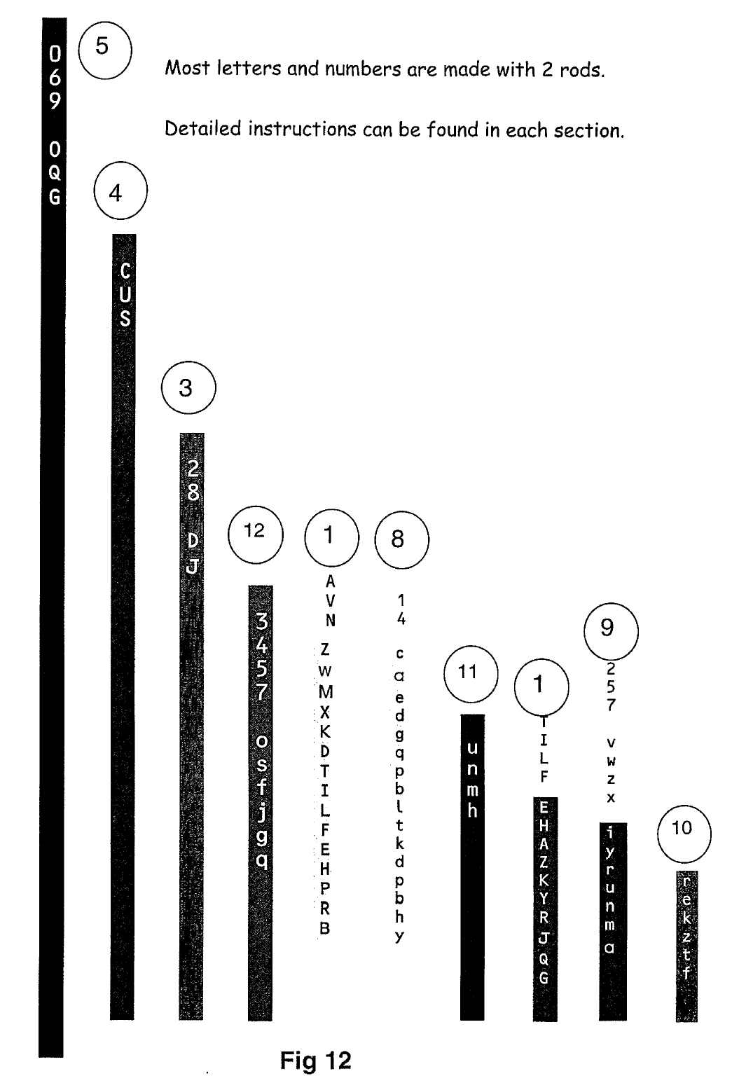

Step 1, Using the clay ropes and the lowercase guide (FIG. 9), measure a clay rope 34 to the first lowercase measuring rod 32. Connect the rod at the ends to form a circle shape for the letter o.

Step 2. Form and measure clay rope 58 against second lowercase rod 56. Form into a curve to make the letter c

Step 3 Form and measure clay rope 58 against second lowercase rod 56. Curve the rod 58 into a “c” shape. Form and measure clay rope 46 against third lowercase measuring rod 44. Attach rope 46 vertically to the right side of the open curve of the aforementioned “c” shape in Step 3 to make the lowercase a.

Step 4 To make the lowercase e, measure and cut one yellow rod and one small orange rod. Curve the longer piece like a c and place the small orange piece horizontally inside the curve and attach at one end of the top of the “c” to create a lowercase e.

Continue making lowercase letters according to the colored rod directions.

Fourth lowercase measuring rod 50 and clay rope 52 are used to form the lowercase letters “u, n, m, and h.”

Fifth lowercase measuring rod 38 is used to form lowercase letters “r, e, k, z, t, and f.”

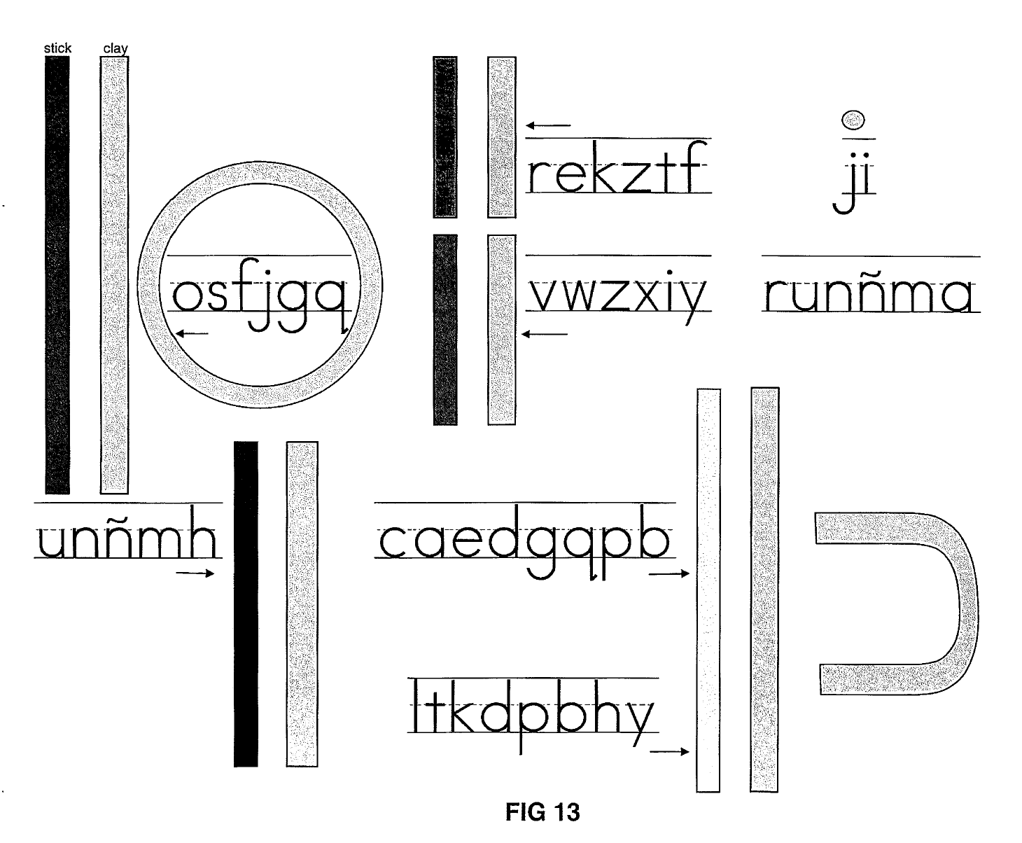

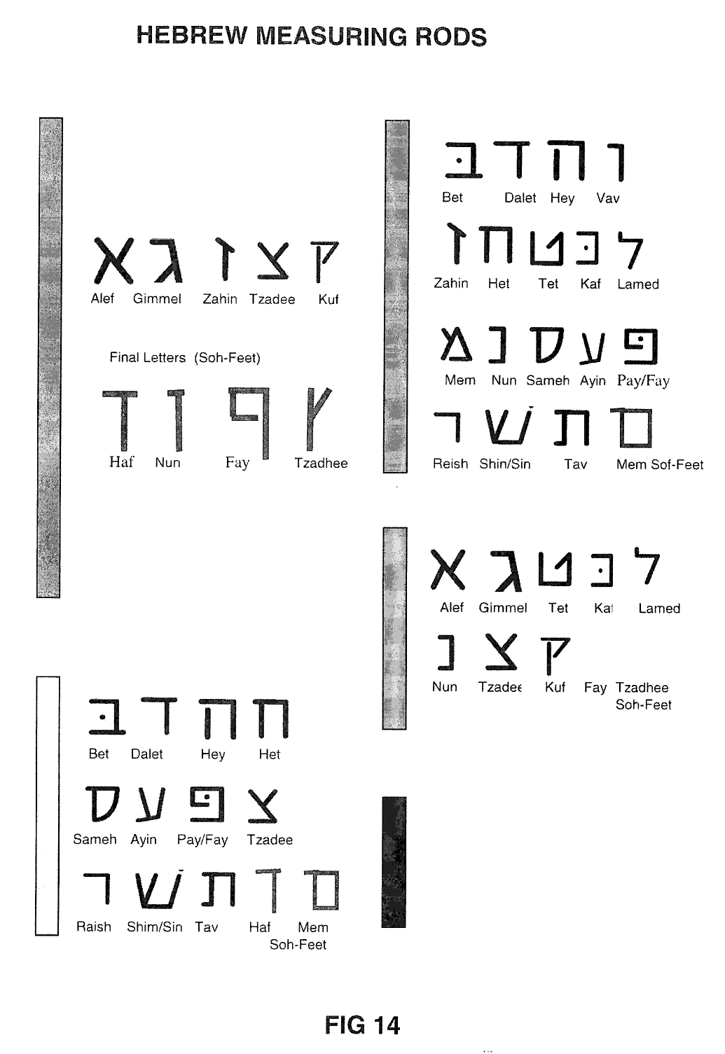

Spanish letters are created in the same way as shown in FIG. 13. A different set of colored rods and tables are available to create Hebrew letters in the same manner, as shown in FIG. 14. Numbers 0 through 9 are able to be made in a similar fashion—using specified colored measuring rods.

The letter groups shown next to respective measuring rods in each of FIGS. 2 and 9 are used to form and teach groups of letters.

Important Letter Blends (Phonemes)

Using the Lower Case letter formation guides create the following letter blends and words that either start or end with these letter combinations. Make a picture of each word. Have your students pay particular attention to these letter sequences within the word. It is important that they visually see and make these combinations before they can master what their sounds are.

Example: sh=shirt ch=church
sh ch th ck
qu ce
er ed tion

ai ou ea oa ow igh eigh ay ie aw ee ey ue ew au oo ui oy oi

Order vs. Out of order or Disorder:

This concept is crucial for a 3D Learner. Sequencing skills are often weak.

In order for students to master spelling or word recognition, it is necessary for them to SEE the order of the letters in a particular word. Sounding out a word is difficult if they do not create a good picture of what the word looks like. Going over the concept of “order” and “out of order” is important for the student to both internalize and make examples of in clay.

(Note: “out of order” signs mean something is broken, so if a word is not in the correct order, either letters in the wrong order or missing letters, then it is NOT that word., and therefore “Out of order”.)

Try using their name as an example.

Examples: alphabet, numbers, ordering in a restaurant, getting dressed. Emphasize that everything has an order to it. Play a game to notice the order of something—how many can they notice?

Once they have mastered making words (next section), the “order” words are important to present in as many ways as possible. This will help emphasize sequencing skills.

In preferred embodiments, each measuring rod has the following length.

FIG. 2

rod 14 26.5 cms

rod 16 20 cms

rod 22 15 cms

rod 24 9.5 cms

rod 28 5.5 cms

FIG. 9

Rod 32 11 cms

rod 38 4 cms

rod 44 5 cms

rod 50 8 cms

rod 56 9.5 cms
Testing and Results

Test 1

A third-grade class made up of 18 students was instructed as to the formation of letters and words using the present invention.

The students were further instructed to form a typical 20 word spelling list using the present invention. The students formed each letter of each word on the 20 word spelling list.

After each word was formed using clay rods of the present invention, each student hand wrote each word.

The students were then given a typical third-grade spelling tests using each of the 20 words. The teacher reported that all 18 third-grade students received a 100% score on this spelling test. The teacher further reported that this particular class of third-grade students had not previously patent all 18 students score 100% on any spelling test. The teacher attributed the test scores to the formation of letters and words according to the present invention.

Test 2

A side-by-side comparison was undertaken using the present invention as compared with the Handwriting Without Tears® system.

A third-grade teacher in a class of autistic students used the present invention alongside the Handwriting Without Tears® system.

The teacher noted significant differences in students ability to retain spelling and meaning of words forms when those words were formed from according to the present invention as opposed to words forms using the Handwriting Without Tears® system.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A system and method for teaching comprising:
a. a plurality of measuring rods;
b. clay;
c. forming at least one rope with said clay;
d. forming objects with said clay rope corresponding to said formed letter;
e. recording a list of said objects formed and said corresponding letter.

2. The system and method of claim 1 wherein said at least one letter comprises forming phonemes.

3. The system and method of claim 1 wherein a word is formed with said clay.

4. The system and method of claim 1 wherein the concept of order of letters is taught.

5. The system and method of claim 1 wherein a plurality of words are placed in an order.

6. The system and method of claim 1 wherein an ordered sequence is prepared based on a word formed of said clay.

7. The system and method of claim 1 wherein a plurality of ordered sequences are created based on a word formed of said clay.
